(19) United States
(12) Patent Application Publication
(10) Pub. No.: US 2015/0193315 A1
(43) Pub. Date: Jul. 9, 2015

(54) METHOD AND DEVICE FOR MANAGING MULTIPLE SNAPSHOTS OF DATA STRORAGE DEVICE

(71) Applicant: ELECTRONICS AND TELECOMMUNICATIONS RESEARCH INSTITUTE, Daejeon (KR)

(72) Inventor: Seung Kook CHEONG, Daejeon (KR)

(21) Appl. No.: 14/591,119

(22) Filed: Jan. 7, 2015

(30) Foreign Application Priority Data
Jan. 7, 2014 (KR) 10-2014-0001669

(51) Int. Cl. G06F 11/14

(52) U.S. Cl. CPC G06F 11/1469; G06F 11/1451; G06F 2201/84

(57) ABSTRACT

A method and device for managing multiple snapshots of data storage device is provided. A method of backing up multiple snapshots includes determining whether to perform a copy on write (COW) operation when a write or update operation is performed on a data block of the storage medium, backing up original data of the data block of recording the original data in a snapshot storage location when it is determined to perform the COW operation, and recording snapshot mapping information of recording a time and a physical address (PA) in which the original data is recorded in the snapshot storage location in a linked list (LL) corresponding to a logical address (LA) of the data block.

### CLAIM FOR PRIORITY

This application claims priority to Korean Patent Application No. 2014-0001669 filed on Jan. 7, 2014 in the Korean Intellectual Property Office (KIPO), the entire contents of which are hereby incorporated by reference.

### BACKGROUND

1. Technical Field

Example embodiments of the inventive concept relate in general to technology of backing up data recorded in a data storage medium and recovering the data in the data storage medium, and more specifically, to technology of effectively generating and managing multiple snapshots in a solid state drive (SSD), a hard disk drive (HDD), or a hybrid storage device combining them.

2. Related Art

A backup refers to temporary storage, and in an information technology (IT) field, refers to a data backup. Generally, the backup means the data backup. A reason why the backup is needed is mainly in order to prepare for the risk of data loss, and the backup is generally performed by avoiding when a system in which data is stored is frequently used.

Since lots of time and resources are needed to back every data up, generally, the backup is periodically performed in stages according to a backup schedule. For instance, the backup of the every data is performed once every three months and in a morning time zone in which the system is not frequently used. Further, an incremental backup is performed once every week, and thus a load of the system and a storage capacity of the backup data are dispersed.

Further, a system in which real-time transaction data is important uses a method of repeatedly recording a circumstance in which a write or update operation on a data block of a storage device is performed in a data storage location and a file of an archive type, and generating and continuously recording another archive file when a constant file size (for example, 10 Gbyte) is filled.

There is a method of dispersively storing in various places by considering importance of data in an aspect of the data backup location. In order to prepare for an unpredictable accident, a method of storing a copy of backup data in a place of a faraway distance may be considered.

Meanwhile, an access of an aspect for continuing a service itself as well as a data backup is considered in a system in which, stability of data transaction is extremely important, that is, a fault tolerant system. For instance, there is a method of generating one logical disk drive by combining a plurality of physical disk drives and storing data in a logical disk drive in an operating system. This method can normally operate the logical disk drive using a remaining physical disk drive which normally operates even when a portion of a physical disk drive is damaged.

Technologies used herein are a redundant array of inexpensive disk (RAID) system, a data mirroring, etc. Further, the logical disk drives do not need to be in the same server storage and in even the same place. That is, a network attached storage (NAS) or a storage area network (SAN) which is a network of totally managing by connecting different types of data storage devices to one data server are emerged.

A backup target may be determined in units of files, folders, disks, or partitions. The backup target may be determined according to a restoration scenario of data to be restored. There are a method of backing up only a file and a folder corresponding to data content, a method of backing up only an operating system and application software, and a method of maintaining only a basic setting value. A backup medium may be a floppy disk, a magnetic tape, an optical disk, a flash memory, an optical magnetic disk, a hard disk, etc.

Meanwhile, the data backup may be used when not only preparing for a loss of data but also recovering data of a desired recovery time. For this, a time stamp idea, that is, an idea of storing a file and a directory structure at a specific time of a data storage medium has been proposed. This is called a snapshot, and the snapshot should be distinguished from when it is used as a general dictionary meaning. That is, the snapshot means a collection of computer files and directories which are present and maintained for a while in the past.

Generally, a hybrid storage system using by combining different types of storages (SSD, HDD, etc.) has a mapping table of mapping a logical address included in an input/output (I/O) request from a virtual file system to an actual block location of a physical storage device. The mapping table integrates two or more storage devices constituting the hybrid storage system. The mapping table is updated when a new block is allocated or a block is moved.

The snapshot in the hybrid storage system is generated through the following operations. First, a virtual snapshot storage device is generated, and a new input and output operation to an original storage device is delayed. At the same time, the new input and output operation is waited until the input and output operation which is currently being performed is ended. When every input and output operation is ended, the mapping table of the original storage device is copied to the snapshot storage device. When the mapping table is copied, the snapshot generation operation is ended, and the input and output operation is normally allowed.

When a write operation is performed in the original storage device after the snapshot is generated, the write operation on the original storage device is performed after copying and storing a block in which data to be changed is included in a storage space allocated to the snapshot and specifying a corresponding block of the snapshot mapping table. When the mapping table and the snapshot mapping table of the original storage device is updated, consistency of the storage device is maintained only when the updated content is stored in the disk.

A mass storage system uses a concept of extent which is a set of physically continuous blocks in order to efficiently manage the mapping table and the storage space. When a size of the hybrid storage device is 1 Tbyte, a size of one entry of the mapping table is 22 byte, and a size of the extent is 32 Kbyte, a storage space to be allocated for the mapping table is about (1T/32K)*22=700 Mbyte. Accordingly, when about 100 snapshots are generated, a space of about 70 Gbyte should be allocated for the mapping table of the snapshots. Further, each snapshot requires a separate space for storing a copy of the extent in the write operation.

In addition, when a copy on write (COW) operation is performed besides a burden of the storage space described above, an additional write operation should be performed when the mapping table is updated. That is, when the write operation on the original storage device is performed after 100 snapshots are generated, an input and output operation due to the COW operation and 100 write operations generated while the mapping table of each snapshot is changed are generated. This is an important factor of deteriorating performance of the storage device.

### SUMMARY

Accordingly, example embodiments of the inventive concept are provided to substantially obviate one or more problems due to limitations and disadvantages of the related art.

Example embodiments of the inventive concept provide a method and device for managing multiple snapshots of a data storage device capable of generating one snapshot mapping table for maintaining the multiple snapshots and effectively maintaining an image when a snapshot is generated by recording a generating time of each snapshot and a copying time in a write operation on each block using a time stamp in a mapping table-based data storage device mapping and managing a logical address and a physical address of a data block.

Example embodiments of the inventive concept also provide a method and device for managing multiple snapshots of a data storage device capable of minimizing a storage space and an input and output operation time required to maintain the snapshots by performing only one copy on write operation when a data input operation is performed in an environment that the multiple snapshots are maintained.

In some example embodiments, a method of backing up multiple snapshots in which a device for managing a snapshot image of a storage medium performs, includes, determining whether to perform a copy on write (COW) operation when a write or update operation is performed on a data block of the storage medium, backing up original data of the data block of recording the original data in a snapshot storage location when it is determined to perform the COW operation, and recording snapshot mapping information of recording a time and a physical address (PA) in which the original data is recorded in the snapshot storage location in a linked list (LL) corresponding to a logical address (LA) of the data block.

Here, the determining whether to perform the COW operation may determine whether to satisfy an order relation condition of each of a recent update time of an original mapping table corresponding to a logical address of the data block, a time in which the write or update operation is performed, and a recent capture starting time of a snapshot list.

Also, the order relation condition may be determined to perform the COW operation when the recent update time of the original mapping table is before a time in which the write or update operation is performed and the recent capture starting time of the snapshot list, and not to perform the COW operation when the recent update time of the original mapping table is after the time in which the write or update operation is performed and the recent capture starting time of the snapshot list.

Further, after the determining of whether to perform the COW operation, the method of backing up the multiple snapshots may further include overwriting the original data of the data block with data to be updated, and recording an overwritten time in the original mapping table when it is determined not to perform the COW operation.

Here, the linked list may be included in a snapshot mapping table, and be extended so as to record at least one piece of COW information.

Also, the snapshot mapping table may include a field in which the logical address is recorded, and the linked list corresponding to the logical address, and the linked list may include a field in which a physical address corresponding to the logical address is recorded, and a field in which a time in which the linked list is written is recorded.

Here, after the recording of the snapshot mapping information, the method of backing up the multiple snapshots may further include overwriting the original data of the data block with data to be updated, and recording an overwritten time in the original mapping table.

In other example embodiments, a method of recovering multiple snapshots in which a device for managing a snapshot image of a storage medium performs, includes, determining a data block to be recovered among arbitrary data blocks of the storage medium when an event of recovering to a specific snapshot time of the storage medium is generated, determining a linked list which is a reference target for data recovery among one or more linked lists corresponding to a logical address of the determined data block, and overwriting original data of the determined data block with data recorded in a snapshot storage location based on the determined linked list which is the reference target.

Here, the data block to be recovered may be a block in which an update time of the arbitrary data block is after the specific snapshot time.

Here, the determined linked list may be the fastest linked list among the one or more linked lists in which an update time is after the snapshot time.

In still other example embodiments, a device for managing multiple snapshots in a device for managing a snapshot image of a storage medium, includes, a copy on write (COW) determination unit configured to determine whether to perform a COW operation when a write or update operation is performed on a data block of the storage medium, a data input and output management unit configured to record original data of the data block in a snapshot storage unit when it is determined to perform the COW operation, and a snapshot mapping information management unit configured to record a time and a physical address in which the original data is recorded in the snapshot storage unit in a linked list corresponding to a logical address of the data block.

Here, the COW determination unit may determine whether to satisfy an order relation condition of each of a recent update time of an original mapping table corresponding to the logical address of the data block, a time in which the write or update operation is performed, and a recent capture starting time of a snapshot list.

Also, the order relation condition may be determined to perform the COW operation when the recent update time of the original mapping table is before a time in which the write or update operation is performed and the recent capture starting time of the snapshot list, and not to perform the COW operation when the recent update time of the original mapping table is after the time in which the write or update operation is performed and the recent capture starting time of the snapshot list.

Here, the device for managing the multiple snapshots may further include an original mapping information management unit configured to transmit data to be updated to the data input and output management unit so as to overwrite the original data with the data to be updated, and record an overwritten time in the original mapping table.

Here, the linked list may be included in a snapshot mapping table, and be extended so as to record at least one piece of COW information.

Also, the snapshot mapping table may include a field in which the logical address is recorded and the linked list corresponding to the logical address, and the linked list may include a field in which a physical address corresponding to the logical address is recorded, and a field in which a time in which the linked list is written is recorded.

Here, the device for managing the multiple snapshots may further include a recovery block determination unit configured to determine a data block to be recovered of the storage medium based on an event of recovering to a specific snapshot time of the storage medium, and the recovery block determination unit may determine a linked list which is a reference target among one or more linked lists corresponding to the logical address of the determined data block to be recovered.

Also, the data input and output management unit may overwrite the original data of the data block with data recorded in the snapshot storage unit based on the determined linked list.

Further, the data block to be recovered may be a block in which an update time of the data block is after the specific snapshot time.

Moreover, the determined linked list may be the fastest linked list among the one or more linked lists in which an update time is after the snapshot time.

### BRIEF DESCRIPTION OF DRAWINGS

Example embodiments of the inventive concept will become more apparent by describing in detail example embodiments of the inventive concept with reference to the accompanying drawings, in which:

FIG. 1 is a diagram for describing an initial state of a storage medium in a method of backing multiple snapshots up according to an embodiment of the inventive concept;

FIG. 2 is a conceptual diagram for describing a structure of a snapshot mapping table according to an embodiment of the inventive concept;

FIGS. 3 to 14 are diagrams for describing an example in which a backup operation is performed in stages using a method of backing multiple snapshots up according to an embodiment of the inventive concept; and

FIG. 15 is a block diagram for describing a device for managing multiple snapshots according to an embodiment of the inventive concept.

### DESCRIPTION OF EXAMPLE EMBODIMENTS

While the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements in the accompanying drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, terms used herein may be defined as follows.

In order to store a file and a structure of a directory in a specific time of a data storage medium, a timestamp may be recorded. Since this is similar to a still cut of obtaining an instantaneous still image with respect to a moving picture of a moving object, this may be referred to as a snapshot. As the term used herein, a snapshot image may not have a general dictionary meaning, and may be data status information corresponding to the timestamp time described above. That is, the snapshot may mean a collection of computer files and directories which are present and maintained for a while in the past.

A data block may mean a unit when reading and writing data. That is, a lump of data may be called the data block. A length of the data block may be fixed or varied.

In a copy on write (COW) operation, when a write operation is performed in a storage device after the snapshot is generated, the write operation is performed after copying a corresponding block (an original block) into a reserved storage space before the block is updated. A copy of the image at the time of generating the snapshot is maintained by maintaining a pointer with respect to an original block recorded in a reserved space.

When data is recorded in the storage device, an address of logical data from the point of view of a user (developer) by distinguishing from a physical address (an actual address in which data is recorded in the storage device) may be referred to as a logical address. From the point of view of the user, the storage device is, considered as one continuous space, but in fact, data is scattered in actual storage locations, and the actual storage device may include data of another region.

Hereinafter, exemplary embodiments of the inventive concept will be described in detail with reference to the accompanying drawings. In order to facilitate a comprehensive understanding in the following description, like numbers refer to like elements in the drawings, and duplicated descriptions will be omitted with respect to the like elements.

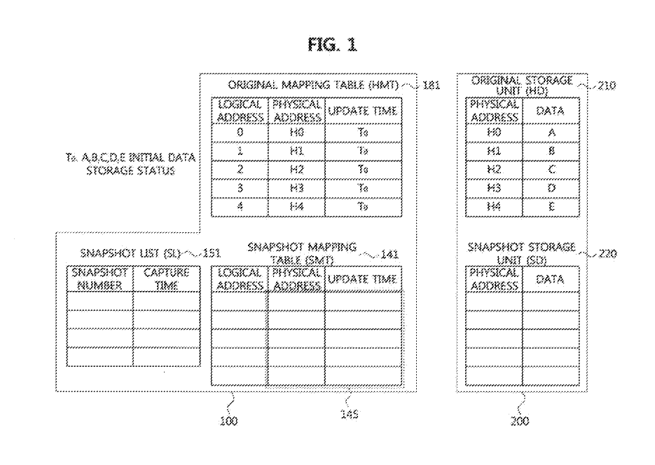

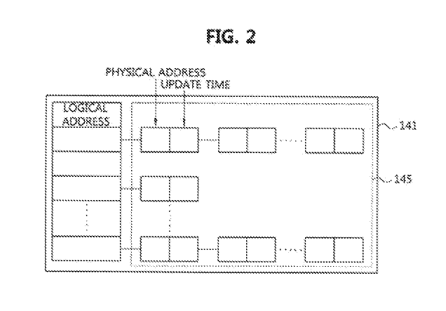

FIG. 1 is a diagram for describing an initial state of a storage medium in a method of backing multiple snapshots up according to an embodiment of the inventive concept, and FIG. 2 is a conceptual diagram for describing a structure of a snapshot mapping table 141 according to an embodiment of the inventive concept.

Referring to FIGS. 1 and 2, in order to solve a performance deterioration problem due to a burden of a storage space and an additional read and write operation of a general snapshot processing method, a method of sharing the snapshot mapping table 141 may be proposed.

In a mapping table-based storage device (a hybrid storage device combining a solid state drive (SSD) and a hard disk drive (HDD) is a representative example), an original mapping table 181 (hereinafter, for example, this may be referred to as a hybrid mapping table (HMT) of a hybrid storage device) in which the physical address in which data is actually recorded and the logical address from the point of view of the user are mapped may be constituted by a field representing each of the logical address (LA) of the data block, the physical address of a storage device 200, and an update time. The data block may be extended in units of extents.

An original storage unit 210 (this may be referred to as a hybrid device (HD)) may store actual data with respect to each extent represented in the original mapping table 181. Further, a hash table-based snapshot mapping table (SMT) 141 may be constituted by the logical address regarding whether to be a backup copy with respect to any extent, the physical address in which the backup copy is stored in a snapshot storage device (SD), and updated time information indicating when the COW operation is performed, when the COW operation on the extent is performed during a system operation. When the copy operation is performed in the COW operation on the same extent, a copy generation time in a corresponding write operation and a physical address of the backup data, stored in the snapshot storage device may be represented using a linked list (LL) 145. Lastly, a snapshot list (SL) 151 may be constituted by a snapshot order number required by a user and capture starting time information.

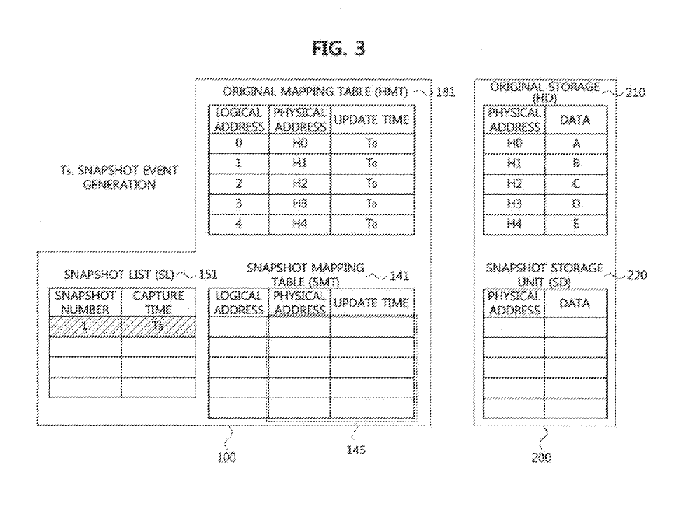

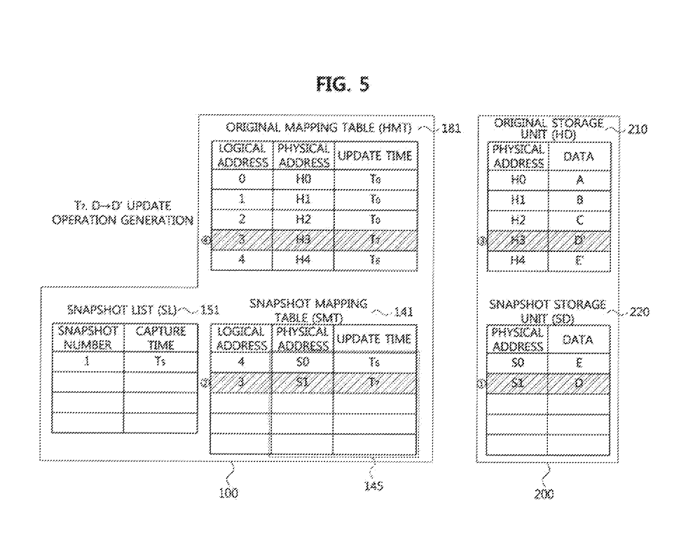

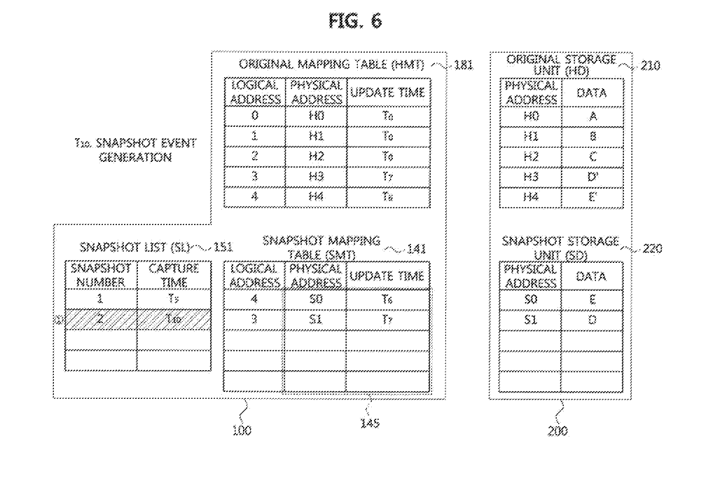

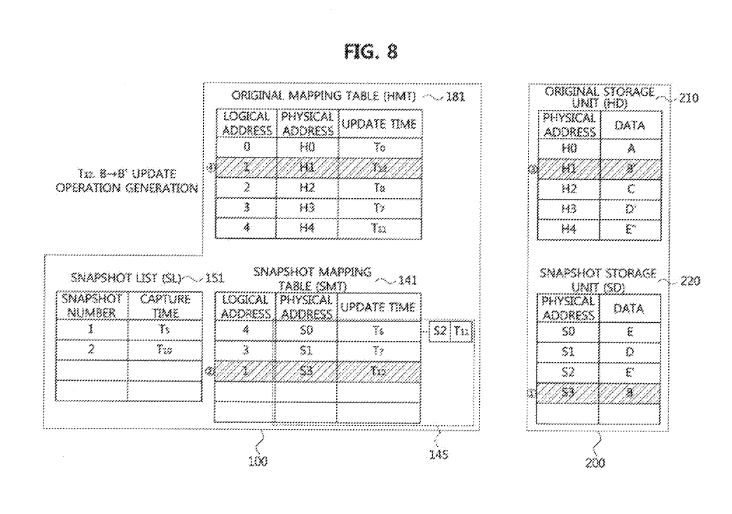

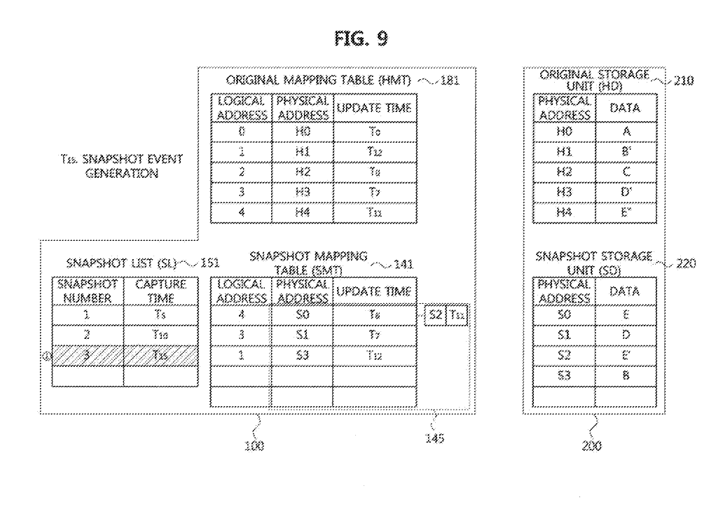

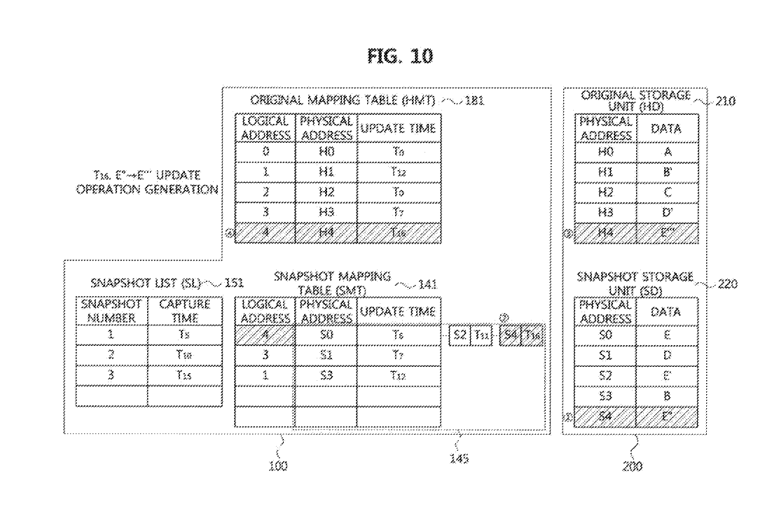

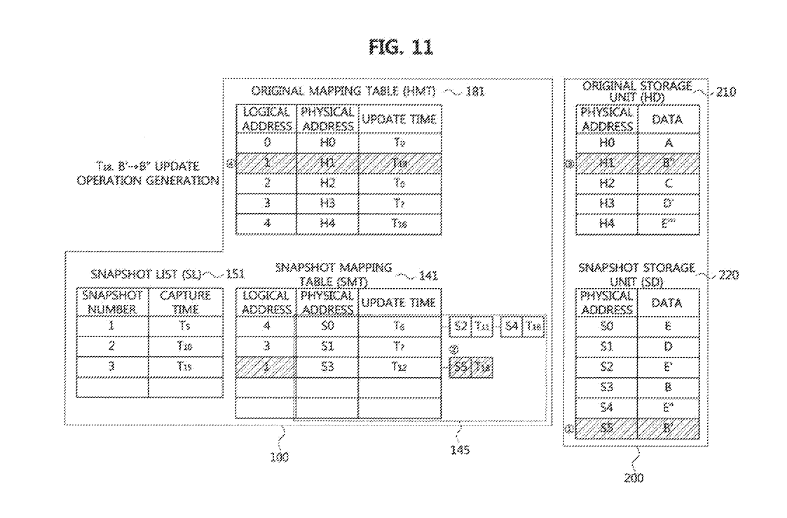

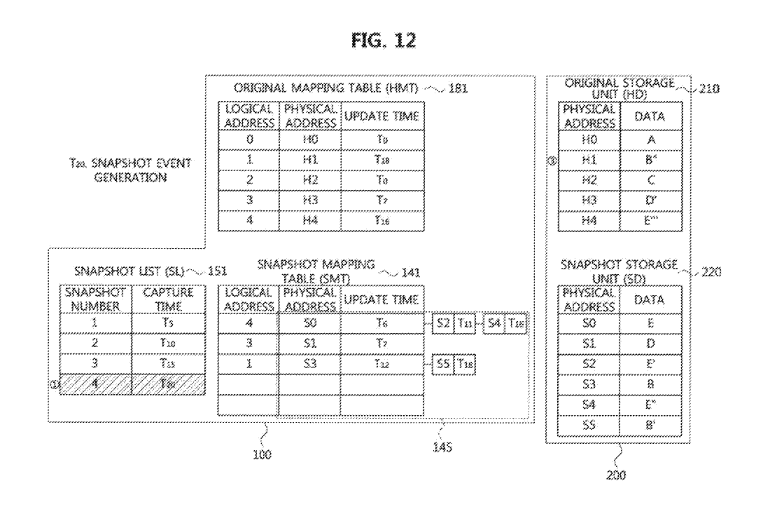

FIGS. 3 to 14 are diagrams for describing an example in which a backup operation is performed in stages using a method of backing multiple snapshots up according to an embodiment of the inventive concept.

Referring to FIGS. 3 to 14, a method of backing up multiple snapshots in which a device managing a snapshot image of a storage medium for a data backup performs may include determining whether to perform the COW operation when a write or update operation is performed on a data block of a storage medium, backing up original data of recording the original data of the data block in a snapshot storage location when it is determined to perform the COW operation, and recording snapshot mapping information of recording a time and the physical address (PA) in which the original data is stored in the snapshot storage location in the linked list (LL) 145 corresponding to the logical address (LA) of the data block.

The determining whether to perform the COW operation may determine whether to satisfy an order relation condition of each of a recent update time of the original mapping table 181 corresponding to the logical address of the data block, a time in which the write or update operation is performed, and a recent capture starting time of the snapshot list 151. The order relation condition may determine to perform the COW operation when the time in which the write or update operation is performed is before the recent capture starting time of the snapshot list 151, and may determine not to perform the COW operation when the time in which the write or update operation is performed is after the recent capture starting time of the snapshot list 151.

The method of backing up the multiple snapshots may further include, after the determining of whether to perform the COW operation when it is determined not to perform the COW operation, overwriting the original data of the data block with data to be changed, and recording an overwritten time in the original mapping table 181.

The linked list (LL) 145 may be included in the snapshot mapping table 141, and be extended so that at least one piece of COW information is recorded. Further, the snapshot mapping table 141 may be constituted by a field in which the logical address is recorded and the linked list 145 corresponding to the logical, address, and the linked list 145 may be constituted by a field in which the physical address corresponding to the logical address is recorded and a field in which a time in which the linked list 145 is written is recorded.

The method of backing up the multiple snapshots may further include, after the recording of the snapshot mapping information, overwriting the original data of the data block with data to be changed, and recording the overwritten time in the original mapping table 181.

When a device for managing multiple snapshots 100 is driven, the snapshot list 151 may be generated at a time specified by a user, and the snapshot order number and the capture starting time may be recorded. FIGS. 3, 6, 9, and 12 are diagrams illustrating an example in which a snapshot list 151 is generated, respectively. First, second, third, and fourth snapshots may be captured at times T5, T10, T15, and T20 in the snapshot list 151. After this, when the snapshot is captured again, the number of a newly generated snapshot may be a next snapshot number, and the capture starting time may be recorded in the snapshot list 151. That is, the method of backing up the multiple snapshots may further include writing the snapshot list 151 of recording the snapshot order number and the capture starting time in response to generation of a snapshot event. The capture starting time may be represented as an absolute time value of a system, and the capture starting time may be substituted by a value obtained by adding a previous capture starting time and a user-specified snapshot capture time slice value.

When updating a snapshot storage unit 220 and the snapshot mapping table 141 in every case that the write or update operation is performed in the extent, since overhead of storage capacity is extremely great, the COW operation may be determined to be performed only when a update time of each extent of the original storage unit 210 (that is, a recent update time of the original mapping table 181 corresponding to the logical address of the data block) is before a newly written update time (that is, a time in which the write or update operation is performed) and the most recent snapshot generation time (that is, the recent capture starting time of the snapshot list), and the snapshot storage unit 220 and the snapshot mapping table 141 may be recorded.

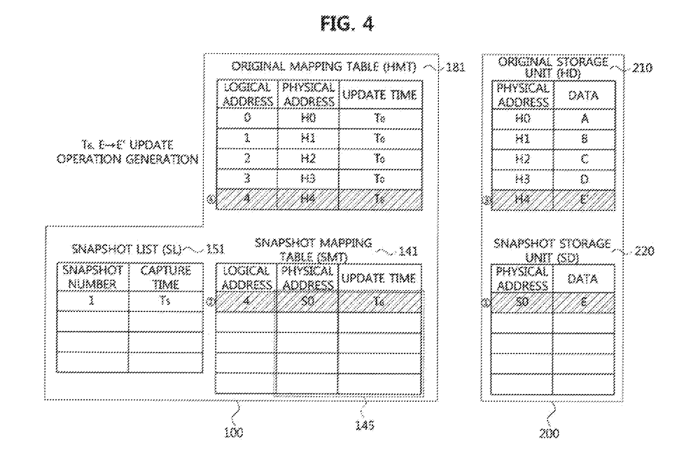

FIGS. 4, 5, 7, 8, 10, 11, and 13 are diagrams illustrating an example of recording in the snapshot storage unit 220 and the snapshot mapping table 141 by performing the COW operation described above. With reference to the snapshot mapping table 141 and the snapshot storage unit 220, when the COW operation is performed, the backup data may be stored in the snapshot storage unit 220. When the COW operation is performed in the original storage unit 210, data of the original storage unit 210 may be copied in an allocated physical address of the snapshot storage unit 220, and new data to be updated or written may be recorded in the physical address of the original storage unit 210 after recording its contents and time in the hash table-based snapshot mapping table 141. For a case that the COW operation is repeatedly performed in the same data block, the snapshot mapping table 141 may have a linked list (LL) 145 capable of being continuously extended, and a method of recording the contents and backing up data in the snapshot storage unit 220 using the structure of the LL 145 may be the same.

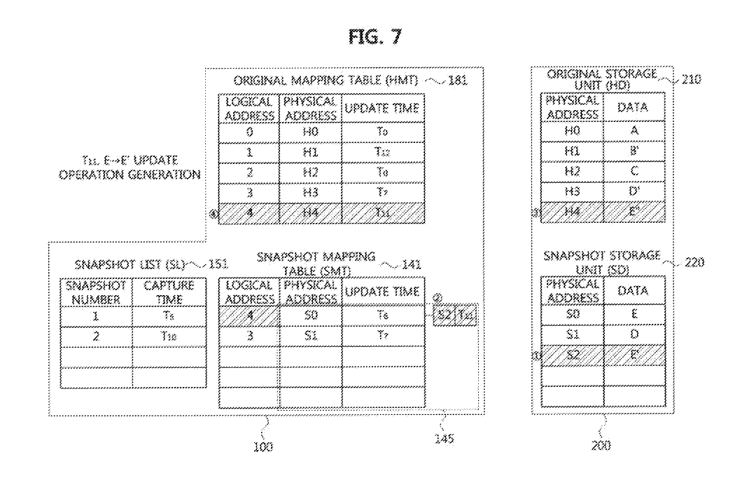

For example, in FIGS. 4, 7, and 10, 4 which is the logical address of the original mapping table 181 may mean a case that a new write request is generated three times, and in a case of FIG. 4 that a first write request is generated, the contents may be recorded in the snapshot mapping table 141, and E′ which is data of a new write request may be stored after E which is data stored in the physical address of an existing original storage unit 210 is copied in the snapshot storage unit 220 of the allocated physical address in the snapshot mapping table 141. In a case of FIG. 7 that a second write request is generated, the write operation may be directly performed in the original storage location since the backup operation is not required when a recent update time of the original mapping table 181 is after a recent snapshot capture starting time with reference to the snapshot list 151, the linked list 145 may be generated by finding the logical address of the snapshot mapping table 141 only when the recent update time T6 of the original mapping table 181 is before the recent snapshot capture starting time T10, and E′ which is data stored in the original storage unit 210 may be copied in the snapshot storage unit 220 by allocating a new physical address, and E″ which is new write request update data may be stored in the original to storage unit 210. An operation on, a third write request may be the same.

Further, an update time of the extent in which the logical address of the snapshot mapping table 141 is 3 is a time T7, and it may be known that the COW operation is performed at the time T7 and a data backup copy of D is stored in the physical address S1 of the snapshot storage unit 220 through the physical address.

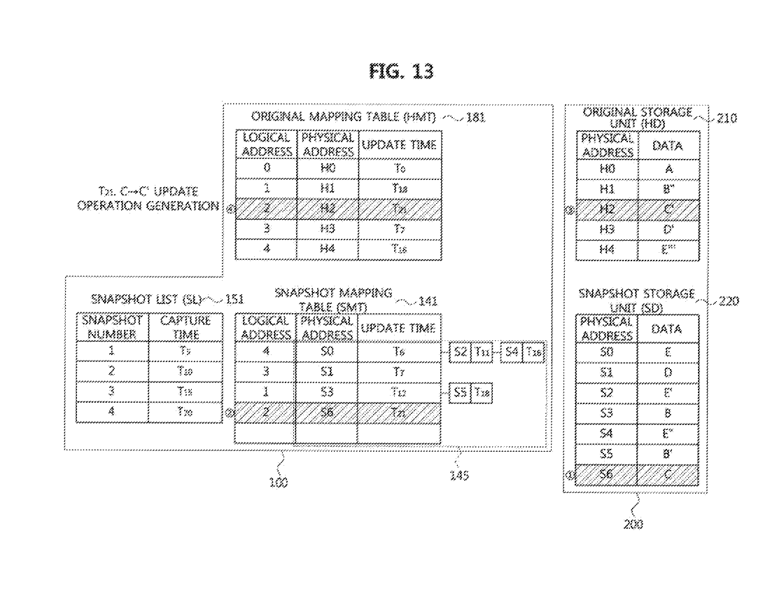

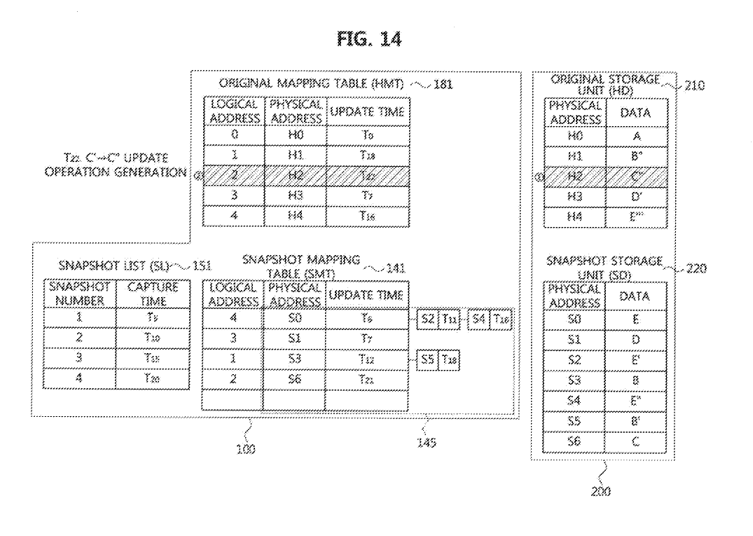

Meanwhile, FIG. 14 illustrates an example of directly storing in the original storage unit 210 without performing the COW operation. A recent capture starting time of the snapshot list 151 is T20, and a time in which an update operation from C′ to C″ is performed in the logical address 2 is T22. It may be known that a recent update time of a current original mapping table 181 is T21 (refer to FIG. 13) and is after the recent capture starting time of the snapshot list 151. In this case, since it is not necessary to back up C′, data of the original storage unit 210 may be overwritten as it is.

A method of recovering data in a multiple snapshot environment may be performed with reference to the COW information in the backup operation. That is, with reference to FIGS. 3 to 14, a method of recovering data will be described.

A method of recovering multiple snapshots performed in a device for managing a snapshot image of a storage medium for data recovery may include, when an event for recovery to a specific snapshot time of the storage medium is generated, determining a data block to be recovered among arbitrary data blocks of the storage medium, determining a linked list 145 which is a reference target of data recovery among one or more linked lists 145 corresponding to the logical address of the determined data block, and recovering data of overwriting original data of the determined data block with data recorded in the snapshot storage location based on the linked list 145 which is the determined reference target.

The data block to be recovered may be a data block in which the update time of an arbitrary data block is after a specific snapshot time. The determined linked list 145 may be the fastest linked list among the one or more linked lists 145 in which the update time is after the snapshot time.

In the recovery based on the snapshot generation time and the storage data, when recovering the snapshot to a specific time, since the COW operation on a corresponding extent from the snapshot recovery time to the present is not performed for a data block having an earlier update time than the recovery time by comparing the recovery time and the update time of each extent of the original mapping table 181, the data block may be maintained as it is without updating in the original mapping table 181. On the other hand, when the update time of each extent of the original mapping table 181 is after the snapshot recovery time, since this means that the COW operation is performed, a corresponding backup data should be recovered by copying each extent of snapshot storage unit 220 to the original storage unit 210 with reference to the snapshot mapping table 141.

When the found extent is generated by a repeated COW operation extents in which the update time among the linked lists 145 is after the snapshot recovery time may be selected, and a time recovery may be performed by selecting an extent having the earliest update time among the selected extents.

For example, when the data storage medium is recovered to the time T10, the data storage medium may be recovered to a time in which the number of the snapshot list 151 is 2. Since extents in which the logical addresses are 0 and 3 among extent entries of the original mapping table 181 have the update times TO and T7 which is equal to or earlier than the recovery time T10, the data block may be a block in which the COW operation is not performed from the recovery time to the present time. Accordingly, during the time recovery, it may not be necessary to recover data of extents in which the logical addresses are 0 and 3. On the other hand, since the update times T18, T22, and T16 of extents in which the logical addresses are 1, 2, and 4 are after the recovery time T10, the data blocks may be blocks in which one or more COW operations are performed from the recovery time to the present time.

The COW operation may be performed twice at the times T12 and T18 for the extent in which the logical address is 1 as shown in the snapshot mapping table 141. Since the COW operation is performed twice and at a time which is after the recovery time T10, data of S3 which is the physical address of an entry corresponding to the time T12 generated, in the past among them may be recovered.

In a case of an extent in which the logical address is 2, the data block may be recovered by checking a corresponding extent and finding the physical address of the recovery data of the snapshot storage unit 220. It can be seen that C stored in the physical address S6 at the time T21 is recovered. At this time, although C″ is stored in the physical address H2 of the original storage unit 210 and data is updated from C′ to C″ at the time T21, since the recovery time is T10, this may not be considered.

In a case of an extent in which the logical address is 4, since the COW operation is performed three times at times T6, T11, and T16 but the time T6 is a time which is equal to or earlier than time T10, it may not be necessary to consider the extent, and E′ which is data of the physical address S2 of T11 entry of the extent of the logical address 4 which is generated at a previous time of times T11 and T16 may be recovered.

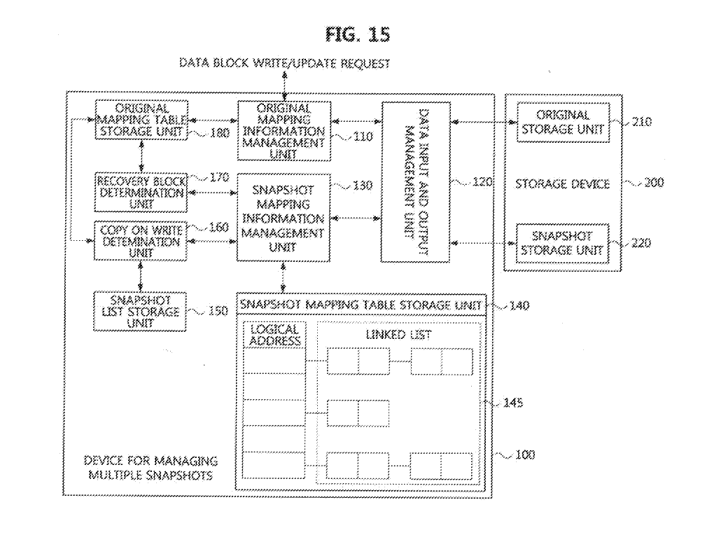

FIG. 15 is a block diagram for describing a device for managing multiple snapshots 100 according to an embodiment of the inventive concept.

Referring to FIG. 15, the device for managing the multiple snapshots 100 of a storage medium for data backup and recovery may include a COW determination unit 160 for determining whether to perform a COW operation when a write or update operation is performed on a data block of the storage medium, a data input and output management unit 120 for recording original data of the data block in the snapshot storage unit 220 when it is determined to perform the COW operation, and a snapshot mapping information management unit 130 for recording a time and a physical address in which the original data is recorded in the snapshot storage unit 220 in the linked list 145 corresponding to a logical address of the data block.

The COW determination unit 160 may determine whether to satisfy an order relation condition of each of a recent update time of the original mapping table 181 corresponding to the logical address of the data block, a time in which a write or update operation is performed, and a recent capture starting time of the snapshot list 151. The order relation condition may be determined to perform the COW operation when the recent update time of the original mapping table 181 is before the time in which the write or update operation is performed and the recent capture starting time of the snapshot list 151, and not to perform the COW operation when the recent update time of the original mapping table 181 is after the time in which the write or update operation is performed or the recent capture starting time of the snapshot list 151.

The device for managing the multiple snapshots 100 may further include an original mapping information management unit 110 for transmitting data to be updated to the data input and output management unit 120 so as to overwrite the original data with the data to be updated, and recording an overwritten time in the original mapping table 181.

The linked list 145 may be included in the snapshot mapping table 141, and be extended so that at least one piece of COW information is recorded. Further, the snapshot mapping table 141 may be constituted by a field in which the logical address is recorded and the linked list 145 corresponding to the logical address, and the linked list 145 may be constituted by a field in which the physical address corresponding to the logical address is recorded and a field in which a time in which the linked list 145 is written is recorded.

The device for managing the multiple snapshots 100 may further include a recovery block determination unit 170 for determining a data block to be recovered in the storage medium based on an event of recovering to a specific snapshot time of the storage medium, and the recovery block determination unit 170 may determine the linked list 145 which is a reference target among one or more linked lists 145 corresponding to the logical address of the determined data block to be recovered.

The data input and output management unit 120 may overwrite the original data of the determined data block with data recorded in the snapshot storage unit 220 based on the determined linked list 145.

The data block to be recovered may be a block in which the update time of the data block is after a specific snapshot time. The determined linked list 145 may be the fastest linked list among the one or more linked lists 145 in which the update time is after the snapshot time.

When a write or update request on the data block of the data storage medium enters the original mapping information management unit 110, the COW determination unit 160 of the device for managing the multiple snapshots 100 may determine whether to perform the COW operation with reference to the original mapping table 181 stored in an original mapping table storage unit 180 and the snapshot list 151 stored in a snapshot list storage unit 150.

The snapshot list storage unit 150 may record an order number and a time in the snapshot list 151 whenever a snapshot event is generated, and the snapshot mapping information management unit 130 may control so as to store COW information in a snapshot mapping table storage unit 140 and the snapshot storage unit 220 when it is determined to perform the COW operation. At this time, the data may be recorded in the snapshot storage unit 220 of the storage device 200 through the data input and output management unit 120.

When recovering the data, the recovery block determination unit 170 may determine the data block to be recovered and the linked list 145. At this time, the backup data which is in the snapshot storage unit 220 may be recovered to the original storage unit 210 through the data input and output management unit 120. Hereinafter, since a function of each component of the device for managing the multiple snapshots 100 has been described in the method of backing up and recovering the multiple snapshots, duplicated description thereof will be omitted.

Updated contents should be stored in the storage device 200 whenever the snapshot mapping table 141 is updated, and at this time, consistency of each snapshot can be maintained. In the inventive concept, a data block of maintaining one snapshot mapping table 141 and repeatedly performing the COW operation may be managed in the form of the linked list 145 corresponding to the logical address of the data block. The snapshot mapping table 141 may be stored in a continuous extent, mapping information in which the COW operation is repeatedly performed on one data block may be maintained in the one data block, and input and output costs for maintaining the snapshot mapping table 141 can be minimized.

According to the method and device for managing the multiple snapshots of the inventive concept, when generating the multiple snapshots in the mapping table-based storage medium, the burden of the input and output operation on the snapshot space and the storage device can be minimized through one snapshot mapping table and timestamp-based version management.

Although a separate storage space for each snapshot is generally required, according to the inventive concept, the burden due to the storage space can be reduced by generating the multiple snapshots in one storage device. Further, a problem in that the write operation on the storage device becomes slow in order to maintain the snapshots can be solved. Particularly, in an environment that the update operation is frequently performed like an on-line transaction processing (OLTP), an advantage of the inventive concept can be highlighted when generating and maintaining the snapshots of the storage device.

Exemplary embodiments of the inventive concept may be recorded in a computer-readable record medium by being implemented in the form of program instructions which are executable using various computer components. The computer-readable record medium may include program instructions, data files, data structures, etc., alone or in combination. The program instructions recorded in the computer-readable record medium may be specially designed for the inventive concept, or may be known to those skilled in the art of the computer software field.

Examples of the computer-readable record medium may include a hardware device, which is specially configured to store and execute the program instructions, such as a floptical disk, a read only memory (ROM), a random access memory (RAM), a flash memory, etc. The hardware device may be configured to operate as one or more software modules to perform the method according to exemplary embodiments of the inventive concept, and vice versa. Examples of the program instructions may include mechanical codes which are made by a compiler, and high-level language codes which are executable by, a computer using an interpreter, etc.

While the example embodiments of the inventive concept and their advantages have been described in detail, it should be understood that various changes, substitutions, and alterations may be made herein without departing from the scope of the invention.

What is claimed is:

1. A method of backing up multiple snapshots in which a device for managing a snapshot image of a storage medium performs, comprising:
determining whether to perform a copy on write (COW) operation when a write or update operation is performed on a data block of the storage medium;
backing up original data of the data block of recording the original data in a snapshot storage location when it is determined to perform the COW operation; and
recording snapshot mapping information of recording a time and a physical address (PA) in which the original data is recorded in the snapshot storage location in a linked list (LL) corresponding to a logical address (LA) of the data block.

2. The method of backing up the multiple snapshots of claim 1, wherein the determining whether to perform the COW operation determines whether to satisfy an order relation condition of each of a recent update time of an original mapping table corresponding to a logical address of the data block, a time in which the write or update operation is performed, and a recent capture starting time of a snapshot list.

3. The method of backing up the multiple snapshots of claim 2, wherein the order relation condition is determined to perform the COW operation when the recent update time of the original mapping table is before a time in which the write or update operation is performed and the recent capture starting time of the snapshot list, and not to perform the COW operation when the recent update time of the original mapping table is after the time in which the write or update operation is performed and the recent capture starting time of the snapshot list.

4. The method of backing up the multiple snapshots of claim 3, after the determining of whether to perform the COW operation, further comprising:
overwriting the original data of the data block with data to be updated, and recording an overwritten time in the original mapping table when it is determined not to perform the COW operation.

5. The method of backing up the multiple snapshots of claim 1, wherein the linked list is included in a snapshot mapping table, and is extended so as to record at least one piece of COW information.

6. The method of backing up the multiple snapshots of claim 5, wherein the snapshot mapping table includes a field in which the logical address is recorded, and the linked list corresponding to the logical address, and
the linked list includes a field in which a physical address corresponding to the logical address is recorded, and a field in which a time in which the linked list is written is recorded.

7. The method of backing up the multiple snapshots of claim 1, after the recording of the snapshot mapping information, further comprising:
overwriting the original data of the data block with data to be updated, and recording an overwritten time in an original mapping table.

8. A method of recovering multiple snapshots in which a device for managing a snapshot image of a storage medium performs, comprising:
determining a data block to be recovered among arbitrary data blocks of the storage medium when an event of recovering to a specific snapshot time of the storage medium is generated;
determining a linked list which is a reference target for data recovery among one or more linked lists corresponding to a logical address of the determined data block; and
overwriting original data of the determined data block with data recorded in a snapshot storage location based on the determined linked list which is the reference target.

9. The method of recovering the multiple snapshots of claim 8, wherein the data block to be recovered is a block in which an update time of the arbitrary data block is after the specific snapshot time.

10. The method of recovering the multiple snapshots of claim 8, wherein the determined linked list is the fastest linked list among the one or more linked lists in which an update time is after the snapshot time.

11. A device for managing multiple snapshots in a device for managing a snapshot image of a storage medium, comprising:
a copy on write (COW) determination unit configured to determine whether to perform a COW operation when a write or update operation is performed on a data block of the storage medium;
a data input and output management unit configured to record original data of the data block in a snapshot storage unit when it is determined to perform the COW operation; and
a snapshot mapping information management unit configured to record a time and a physical address in which the original data is recorded in the snapshot storage unit in a linked list corresponding to a logical address of the data block.

12. The device for managing the multiple snapshots of claim 11, wherein the COW determination unit determines whether to satisfy an order relation condition of each of a recent update time of an original mapping table corresponding to the logical address of the data block, a time in which the write or update operation is performed, and a recent capture starting time of a snapshot list.

13. The device for managing the multiple snapshots of claim 12, wherein the order relation condition is determined to perform the COW operation when the recent update time of the original mapping table is before a time in which the write or update operation is performed and the recent capture starting time of the snapshot list, and not to perform the COW operation when the recent update time of the original mapping table is after the time in which the write or update operation is performed and the recent capture starting time of the snapshot list.

14. The device for managing the multiple snapshots of claim 11, further comprising:
an original mapping information management unit configured to transmit data to be updated to the data input and output management unit so as to overwrite the original data with the data to be updated, and record an overwritten time in the original mapping table.

15. The device for managing the multiple snapshots of claim 11, wherein the linked list is included in a snapshot mapping table, and is extended so as to record at least one piece of COW information.

16. The device for managing the multiple snapshots of claim 15, wherein the snapshot mapping table includes a field in which the logical address is recorded and the linked list corresponding to the logical address, and
the linked list includes a field in which a physical address corresponding to the logical address is recorded, and a field in which a time in which the linked list is written is recorded.

17. The device for managing the multiple snapshots of claim 11, further comprising:
a recovery block determination unit configured to determine a data block to be recovered of the storage medium based on an event of recovering to a specific snapshot time of the storage medium,
wherein the recovery block determination unit determines a linked list which is a reference target among one or more linked lists corresponding to the logical address of the determined data block to be recovered.

18. The device for managing multiple snapshots of claim 17, wherein the data input and output management unit overwrites the original data of the data block with data recorded in the snapshot storage unit based on the determined linked list.

19. The device for managing multiple snapshots of claim 17, wherein the data block to be recovered is a block in which an update time of the data block is after the specific snapshot time.

20. The device for managing the multiple snapshots of claim 17, wherein the determined linked list is the fastest linked list among the one or more linked lists in which an update time is after the snapshot time.
